(19) United States
(12) Patent Application Publication
(10) Pub. No.: US 2026/0252984 A1
(43) Pub. Date: Aug. 27, 2026

(54) EMPLOYEE SHIFT SCHEDULING AND ATTENDANCE MANAGEMENT SYSTEM

(71) Applicant: Kingfisher Innovations, Inc., Houston, TX (US)

(72) Inventors: Andrew Brett Gilmer, Parkland, FL (US); Mitchell Gilmer, Wauwatosa, WI (US); Steve Gotberg, Corpus Christi, TX (US); Theresa Ruiz, Little Elm, TX (US); RhaeAnn C. Stark, Corpus Christi, TX (US); Mitchell Kalogridis, Houston, TX (US); Donald Domenico Franco, The Hills, TX (US)

(73) Assignee: Kingfisher Innovations, Inc., Houston, TX (US)

(21) Appl. No.: 19/378,451

(22) Filed: Nov. 4, 2025

Related U.S. Application Data
(63) Continuation-in-part of application No. 19/206,469, filed on May 13, 2025.
Application No. 19/206,469 is a continuation-in-part of application No. 19/063,690, filed on Feb. 26, 2025.

(51) Int. Cl. G06Q 10/0631; G06Q 10/0639; G07C 9/28

(52) U.S. Cl. CPC G06Q 10/063116; G06Q 10/063114; G06Q 10/06393; G07C 9/28

(57) ABSTRACT

An employee shift scheduling and attendance management system is disclosed. The system includes an employee presence detection subsystem configured to detect the arrival of employees using an identification mechanism, a shift scheduling subsystem for generating and managing shift schedules, and a real-time monitoring module to compare arrival data with scheduled shifts. A communication module automatically contacts absent or delayed employees, while a scheduling engine assigns replacements based on criteria including overtime limits, skill data, and regulatory compliance. An automated rescheduling module updates staffing assignments through detection, policy, ranking, and outreach submodules. The system further integrates a training content delivery platform that presents interactive content during sign-in, tracks completion as a key performance indicator, and restricts activation to verified worksites, ensuring compliance, readiness, and workforce efficiency.

### TECHNICAL FIELD

The present invention relates generally to workforce management systems and, more particularly, to an intelligent shift scheduling and attendance management system that automates employee presence detection, schedule creation, real-time monitoring, and replacement assignment. The invention further relates to compliance-based scheduling engines and integrated employee communication systems that optimize staffing efficiency while ensuring adherence to regulatory and operational constraints.

### BACKGROUND

Modern enterprises that rely on shift-based employees face significant challenges in ensuring adequate staffing levels, maintaining attendance compliance, and addressing last-minute absences. Industries such as hospitality, retail, healthcare, logistics, and manufacturing operate with dynamic workforce requirements that fluctuate based on real-time demand, customer volume, and service availability. Manual or semi-automated scheduling methods often result in underutilization of staff, excessive overtime, and regulatory non-compliance.

Traditional workforce management tools primarily function as static scheduling platforms. They rely on managers to manually adjust schedules, verify attendance, and contact replacement employees in case of absenteeism. These systems lack real-time awareness and intelligent decision-making capabilities, making them prone to human error and inefficiency. Further, existing attendance systems often depend on physical timecards or biometric devices that merely record check-in and check-out times without providing predictive insights into potential no-shows.

Additionally, most conventional scheduling software do not integrate employee identification or verification within the scheduling logic. As a result, attendance validation and shift assignment remain disjointed, requiring redundant processes. Many existing systems also fail to maintain transparent audit logs or policy-based compliance checks, which are essential in regulated industries.

With increased workforce mobility, organizations now employ hybrid and gig workers who operate across multiple locations. This further complicates scheduling consistency, especially when different teams or franchises follow varying overtime limits, performance-based ranking criteria, or skill-specific staffing ratios.

Moreover, communication between management and employees regarding shift changes or absences is still largely manual. When an employee fails to arrive for a shift, supervisors often must call or message multiple employees to find a replacement. This reactive approach leads to extended downtime, operational disruptions, and increased costs.

There is, therefore, a strong need for an intelligent, automated scheduling ecosystem that can not only monitor attendance but also predict potential absences, identify compliant replacement employees, and perform real-time rescheduling based on predefined policies and employee performance data. The present invention addresses these challenges by introducing an integrated, AI-driven scheduling and attendance management platform that links employee identification, task verification, and communication modules into a unified, compliant, and responsive workforce management system.

### OBJECTIVES OF THE INVENTION

The primary object of the invention is to provide a system that automates employee shift scheduling, attendance detection, and replacement assignment in real-time.

Another object of the invention is to ensure regulatory compliance, optimize staffing ratios, and minimize overtime costs through intelligent policy-based decision-making.

A further object of the invention is to provide predictive analytics for potential absenteeism and enable automated outreach to available replacement employees.

A still further object is to integrate identification badges or tokens with task completion and safety alert mechanisms, ensuring employee accountability and workplace security.

Another object of the invention is to deliver role-specific training and communication content through an integrated digital platform accessible from the timecard system or mobile devices.

### SUMMARY OF THE INVENTION

The present invention provides an employee shift scheduling and attendance management system designed to enhance operational efficiency, workforce compliance, and real-time staffing adaptability in dynamic work environments. The system integrates employee presence detection, shift scheduling, predictive monitoring, and automated rescheduling functions to ensure optimal resource allocation and adherence to organizational and regulatory standards.

According to a first aspect of the invention, a system for employee shift scheduling and attendance management is provided. The system comprises: an employee presence detection subsystem configured to detect and authenticate the arrival of employees at a worksite using an identification mechanism; a shift scheduling subsystem configured to electronically create, assign, and manage employee shift schedules; a real-time monitoring module configured to compare actual employee presence with scheduled shifts and determine risk of tardiness or absence; a communication module configured to automatically notify absent or late employees and log responses; a scheduling engine configured to identify and assign replacement employees based on predefined criteria including overtime limits, training data, performance scores, and compliance requirements; and an automated rescheduling module comprising detection, policy, ranking, and outreach submodules configured to allocate and confirm replacements in real time.

In one embodiment of the invention, the employee presence detection subsystem comprises a smart identification badge or token configured for wireless communication with the system. The badge or token enables authentication, task logging, and access control, and may also serve as an emergency alert device through which employees can request assistance or trigger alarms during a threat or hazard event.

In one embodiment of the invention, the shift scheduling subsystem electronically generates shift rosters using configurable staffing policies derived from historical scheduling data, performance records, and compliance parameters. The subsystem enables employers to define staffing ratios and budget thresholds, ensuring that the scheduling engine adheres to labour regulations and financial constraints.

In one embodiment of the invention, the real-time monitoring module continuously monitors employee presence data and identifies employees who are at risk of missing a shift based on a predefined threshold time prior to shift commencement. The module triggers automated alerts for potential absences and forwards predictive risk assessments to the scheduling engine.

In one embodiment of the invention, the communication module facilitates automated outreach to employees identified as absent or delayed. The module transmits notifications via mobile application, SMS, or email and logs each response for supervisory review. Responses may automatically update the scheduling engine to initiate replacement allocation if the employee confirms absence.

In one embodiment of the invention, the scheduling engine applies a weighted ranking algorithm to evaluate potential replacements based on overtime history, certifications, peer-group consistency, and availability. The engine dynamically optimizes assignments to maintain workforce efficiency while complying with staffing limits and training requirements.

In one embodiment of the invention, the automated rescheduling module comprises four integrated submodules: a detection submodule that confirms absence events; a policy submodule that ensures compliance with regulatory and organizational rules; a ranking submodule that prioritizes eligible employees; and an outreach submodule that contacts replacements and records their acceptance or rejection. The scheduling submodule finalizes the updated shift and synchronizes it with the master schedule.

In one embodiment of the invention, the system maintains a dynamic on-call list that updates in real-time as employee availability changes. This list is continuously synchronized with attendance data, ensuring that only active and qualified employees are considered for replacement scheduling.

In one embodiment of the invention, the system includes a mobile or web-based interface that allows employees to view schedules, respond to shift change requests, and acknowledge assigned training modules. The interface also allows supervisors to monitor staffing levels and review audit logs of scheduling decisions.

In one embodiment of the invention, the employee identification badge or token maintains a local alert log containing details of active and archived alerts. The stored data is periodically synchronized with the central system to update employee safety records and incident histories.

In one embodiment of the invention, the scheduling engine minimizes overtime and optimizes workforce distribution by balancing employee workload across shifts. The system dynamically recalculates shift assignments based on performance data, attendance reliability, and forecasted demand.

In one embodiment of the invention, the system integrates a training and communication delivery platform configured to present informational and interactive content to employees during the timecard sign-in process. The content is tailored to the employee's role, past performance, and upcoming shift objectives.

In one embodiment of the invention, the training content delivery platform notifies employees via mobile device or workstation display and requires completion of mandatory content prior to timecard activation. The system tracks completion metrics such as content completion time and overall completion rate relative to shifts worked.

In one embodiment of the invention, the timely completion of assigned training content is recorded as a performance key performance indicator (KPI) and used as a criterion for determining employee eligibility for incentive-based compensation or tip-pool participation.

In one embodiment of the invention, the training content delivery platform enforces geolocation-based restrictions using geofencing technology. The content cannot be accessed or completed unless the employee's location is verified within a predefined radius of the authorized worksite.

In one embodiment of the invention, the system interface generates analytics dashboards that display real-time schedule efficiency, staffing costs, attendance trends, and performance metrics. Historical data is retained for compliance reporting and workforce optimization.

According to a second aspect of the invention, a method for employee shift scheduling and attendance management is provided. The method comprises detecting employee presence using an identification mechanism; generating and storing shift schedules electronically; monitoring attendance data to detect potential absences; automatically contacting at-risk or absent employees; and invoking a scheduling engine to assign replacements based on weighted compliance and performance criteria.

In one embodiment of the invention, the method further comprises dynamically updating the on-call list of eligible replacements based on real-time availability and executing automated outreach workflows for shift confirmation and assignment.

In one embodiment of the invention, the method includes delivering mandatory training content at sign-in, verifying completion metrics, and associating completion data with employee eligibility records.

In one embodiment of the invention, the system employs encryption and multi-factor authentication to secure attendance, scheduling, and training data, ensuring integrity and preventing unauthorized modification.

In one embodiment of the invention, alerts and notifications generated by the communication module are categorized by severity and transmitted through multiple channels, including push notifications, SMS, email, and dashboard alerts.

In one embodiment of the invention, all scheduling events, attendance records, and communication logs are timestamped and stored with geolocation metadata for auditability and regulatory compliance.

In one embodiment of the invention, the system applies predictive analytics to historical attendance and performance data to identify behavioural trends, forecast absenteeism, and proactively recommend scheduling adjustments.

In one embodiment of the invention, the communication module escalates critical alerts automatically to higher-level administrators or supervisors based on severity thresholds defined within the compliance framework.

In one embodiment of the invention, the employee interface provides real-time insights and notifications regarding assigned shifts, pending approvals, upcoming training sessions, and compliance requirements.

In the context of this specification, the term “employee presence detection subsystem” includes any hardware or software capable of identifying, authenticating, and logging the presence of a user within a defined worksite area. This may include RFID badges, biometric readers, NFC tokens, Bluetooth beacons, or mobile-based geolocation systems.

In the context of this specification, the term automated rescheduling module refers to a set of programmatic submodules responsible for absence detection, policy verification, employee ranking, and replacement confirmation through automated communication workflows.

In the context of this specification, the term scheduling engine refers to an artificial intelligence or rules-based computational system that dynamically assigns employees to shifts based on eligibility, performance, availability, and compliance parameters.

In the context of this specification, the term communication module refers to an automated system capable of transmitting and logging multi-channel notifications, including SMS, push alerts, email, or in-app messages.

In the context of this specification, the term training content delivery platform refers to a digital interface integrated with a timecard system, capable of presenting mandatory or optional role-based content and recording completion metrics for compliance evaluation.

In the context of this specification, the term on-call list refers to a dynamically updated database of employees available for replacement scheduling based on real-time attendance, shift completion, and availability data.

In the context of this specification, the term staffing ratio policy refers to an employer-defined rule that establishes minimum or optimal employee-to-task ratios for different roles or departments, used as a constraint in automated scheduling.

In the context of this specification, the term predictive analytics refers to the application of data models and algorithms to forecast absenteeism, optimize resource allocation, and enhance workforce performance outcomes.

In the context of this specification, the term alert refers to a system-generated message that notifies users or administrators of a missed shift, schedule deviation, policy violation, or compliance breach, delivered through one or more communication channels.

In the context of this specification, the term compliance tracking refers to the continuous monitoring of employee behaviour, attendance, and performance relative to organizational policies, and the generation of reports or alerts when deviations are detected.

In the context of this specification, the term geo-fencing refers to the use of location-based boundaries to verify the physical presence of an employee within a defined area prior to authorizing access to training modules or attendance validation.

In the context of this specification, the term employee shift scheduling system encompasses both hardware and software components configured to automate, monitor, and optimize workforce deployment, ensuring transparency, operational continuity, and compliance with regulatory frameworks.

### BRIEF DESCRIPTION OF THE ACCOMPANYING DRAWINGS

The accompanying drawings illustrate the best mode for carrying out the invention as contemplated and set forth hereinafter. The present invention may be more clearly understood from a consideration of the following detailed description of the preferred embodiments taken in conjunction with the accompanying drawings, wherein like reference letters and numerals indicate the corresponding parts in various figures in the accompanying drawings, and in which:

FIG. 1 is a block diagram showing various components of an employee shift scheduling and attendance management system, in accordance with an embodiment of the present invention.

FIG. 2 illustrates an internal architecture of the employee presence detection subsystem, showing the identification badge or token, its interface with the system upon arrival, and its role in attendance detection and alert notification, in accordance with an embodiment of the present invention;

FIGS. 3A-3B illustrate a method for employee shift scheduling and attendance management, in accordance with an embodiment of the present invention; and

FIG. 4 illustrates an employer dashboard interface showing configuration of staffing-ratio policies, automated alerts for deviations, and real-time visibility of attendance and schedule adjustments, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

As used herein, the terms “comprises,” “comprising,” “includes,” “including,” “has,” “having,” and any variations thereof are intended to denote non-exclusive inclusion. Accordingly, a process, method, article, or apparatus that comprises a list of elements is not limited to those elements alone, but may include other elements not expressly listed or inherent to such a process, method, article, or apparatus. Unless expressly stated otherwise, the term “or” as used in this specification refers to an inclusive or rather than an exclusive or. Therefore, a condition stated as “A or B” shall be interpreted to mean any of the following: A is true (or present) and B is false (or not present); A is false (or not present) and B is true (or present); or both A and B are true (or present). Additionally, any examples or illustrations given herein are not to be regarded as restrictions on, limits to, or express definitions of any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification, and all such embodiments are intended to be included within the scope of that term or terms. Language designating such non-limiting examples and illustrations includes, but is not limited to: “for example,” “for instance,” “e.g.,” “in one embodiment”.

The present invention relates to an integrated employee shift scheduling and attendance management system that enhances workforce efficiency, attendance compliance, and labour regulation adherence through a multi-module architecture. The system ensures that scheduled employees report to their assigned shifts on time, and that staffing levels remain within policy-defined ratios even in the event of absences, late arrivals, or unplanned call-outs. The invention may be implemented across diverse operational environments, including retail, hospitality, healthcare, manufacturing, logistics, and enterprise facilities, where accurate attendance tracking and timely rescheduling are critical to uninterrupted service delivery.

The system comprises an employee presence detection subsystem, a shift scheduling subsystem, a real-time monitoring module, a communication module, a scheduling engine, and an automated rescheduling module. Each module is configured to perform specific functions while maintaining seamless interoperability with other modules through a centralized communication bus. The communication bus facilitates continuous data exchange between subsystems and ensures synchronization of shift schedules, employee status updates, and rescheduling decisions in real time.

The employee presence detection subsystem is configured to detect and log the arrival of employees at a worksite through an identification mechanism. This may include an RFID-based identification badge, biometric authentication, mobile credential, or NFC token assigned to each employee. Upon arrival, the subsystem verifies the employee's credentials, logs the check-in event, and transmits the data to the shift scheduling subsystem and real-time monitoring module. The system ensures that the employee's attendance record is accurately maintained and that any deviation from scheduled reporting time triggers further analysis by the monitoring module.

The shift scheduling subsystem is responsible for electronically creating, storing, and managing shift schedules for all employees. It allows an employer or supervisor to define shift timing, skill requirements, and staffing ratios in accordance with operational and regulatory standards. The subsystem maintains historical scheduling data, performance metrics, and attendance logs, enabling data-driven workforce allocation. It may also interface with third-party workforce management platforms or payroll systems to ensure compliance with applicable labour laws and contractual obligations.

The real-time monitoring module continuously compares employee arrival data from the presence detection subsystem with scheduled shift records maintained in the shift scheduling subsystem. When an employee fails to check in within a predefined threshold time before shift commencement, the module automatically identifies the employee as “at-risk” or absent. This event triggers a notification to the communication module, enabling prompt contact with the employee and activation of the automated rescheduling process.

The communication module manages all system-generated communications related to attendance, absences, and scheduling adjustments. It automatically contacts employees via SMS, voice call, email, or push notification and records their responses for managerial review. The communication module also notifies supervisors or management users of any staffing gaps, ensuring proactive human oversight and operational continuity.

The scheduling engine serves as the decision-making core of the system. It evaluates replacement options when an employee is identified as absent or unavailable. The engine applies a weighted ranking algorithm that considers predefined criteria, including overtime limits, skill certifications, regulatory compliance, performance history, and employee seniority. The engine dynamically generates optimized replacement recommendations, ensuring that workforce allocation remains compliant, efficient, and cost-effective.

The automated rescheduling module is an intelligent orchestration layer that executes replacement workflows upon detection of a no-show or call-out. It comprises detection, policy, ranking, and outreach submodules. The detection submodule identifies unfilled shifts in real time; the policy submodule enforces labour and regulatory compliance; the ranking submodule prioritizes available replacements based on system-defined weightages; and the outreach submodule automatically communicates new shift offers and confirms acceptances. Once confirmed, the schedule is updated and synchronized across all system modules.

The modules are interconnected and managed through the communication bus, which provides a unified data exchange layer. The bus ensures that all modules—presence detection, scheduling, monitoring, communication, and rescheduling—operate in sync, with data integrity maintained across employee records, attendance logs, and staffing configurations.

The system enables analytics-driven insights into workforce performance and attendance trends through a management dashboard. This dashboard aggregates data from all modules, allowing employers to visualize attendance patterns, shift adherence, and rescheduling frequency. It further supports compliance reporting and predictive workforce planning.

In operation, the system minimizes administrative intervention by automating shift management tasks that traditionally rely on manual oversight. By leveraging real-time attendance detection, dynamic policy enforcement, and predictive scheduling algorithms, the system ensures continuous coverage and optimal resource utilization across all operational shifts.

To ensure reliability and security, communication between modules may be implemented over encrypted channels using secure APIs or wireless protocols such as Wi-Fi, Bluetooth Low Energy (BLE), or LoRaWAN. Authentication and authorization mechanisms safeguard employee data and ensure that only verified users can access scheduling or rescheduling features.

In one embodiment, the system further integrates with timecard or payroll systems to automatically update attendance records, compute compensations, and maintain compliance with labour-hour regulations. Integration with performance tracking and training platforms enables employers to link attendance metrics with employee development and incentive programs.

Through its modular, automated, and data-driven architecture, the system transforms traditional workforce scheduling into an intelligent, self-regulating process. It enhances operational continuity, reduces unplanned absenteeism, and ensures that every shift operates within compliance, budgetary, and performance thresholds.

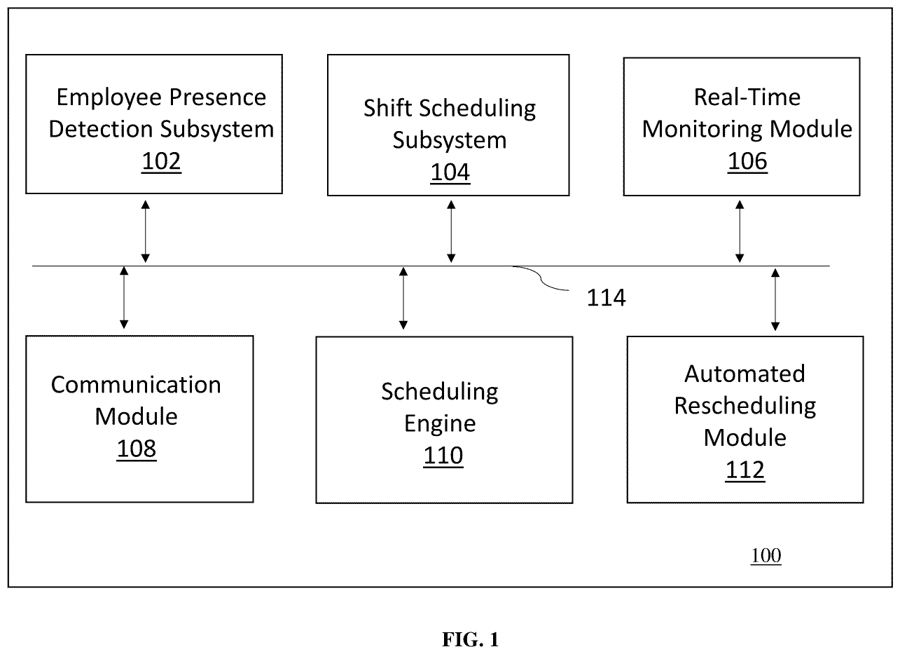

FIG. 1 illustrates a block diagram showing various components of an employee shift scheduling and attendance management system (100), in accordance with an embodiment of the present invention.

The system (100) comprises an employee presence detection subsystem (102), a shift scheduling subsystem (104), a real-time monitoring module (106), a communication module (108), a scheduling engine (110), and an automated rescheduling module (112). All modules are operatively interconnected through a communication bus (114) that facilitates bidirectional data exchange and command synchronization between the components. The communication bus (114) may be implemented as a wired or wireless data channel, including Ethernet, Wi-Fi, or an internal API-based communication interface, enabling seamless interoperability among the functional modules.

The employee presence detection subsystem (102) is configured to detect the arrival of one or more employees at a designated worksite. The subsystem (102) interfaces with an identification mechanism such as an RFID badge, biometric sensor, or mobile-based authentication token. Upon detection, presence data are transmitted via the communication bus (114) to the real-time monitoring module (106) and to the shift scheduling subsystem (104) for verification against stored shift records.

The shift scheduling subsystem (104) electronically creates, stores, assigns, and manages individual or group shift schedules for the workforce. The subsystem (104) communicates scheduling data to the real-time monitoring module (106) and the scheduling engine (110) for dynamic updates based on attendance and operational requirements. In some embodiments, the subsystem (104) provides configurable interfaces enabling employers to define threshold arrival times, staffing ratios, and schedule-generation policies.

The real-time monitoring module (106) continuously compares employee arrival data from the employee presence detection subsystem (102) with the corresponding scheduled shifts maintained in the shift scheduling subsystem (104). If the module (106) determines that an employee has not checked in within a predefined threshold period before the start of a shift, it flags the record and generates a potential “at-risk” indicator for further action. This information is transmitted over the communication bus (114) to the communication module (108) and automated rescheduling module (112) for subsequent processing.

The communication module (108) is responsible for initiating contact with any employee identified as absent or likely to be absent. The module (108) may send automated notifications via SMS, email, push alerts, or voice calls, and log responses received from the employees. The communication module (108) also provides updates to managerial dashboards to ensure supervisory awareness of attendance deviations in real time.

The scheduling engine (110) functions as the computational core of the system. It processes data from the shift scheduling subsystem (104), real-time monitoring module (106), and communication module (108) to evaluate staffing requirements and replacement options. The engine (110) applies a weighted ranking algorithm that considers factors such as overtime limits, training certifications, performance ratings, seniority, and compliance with labour regulations. Based on these parameters, the scheduling engine (110) dynamically recommends or assigns replacement employees to maintain operational continuity.

The automated rescheduling module (112) operates as an intelligent orchestration component that executes workflow logic upon detection of a call-out, no-show, or unplanned absence. The module (112) comprises detection, policy, ranking, and outreach submodules. The detection submodule identifies shift gaps; the policy submodule ensures compliance with predefined labour or union policies; the ranking submodule prioritizes eligible replacements; and the outreach submodule automatically communicates shift offers and confirms acceptances. Upon successful confirmation, the updated schedule is transmitted to the shift scheduling subsystem (104) through the communication bus (114), thereby maintaining synchronization across all modules.

In operation, the coordinated functioning of these modules ensures accurate attendance detection, predictive absence management, and automated shift rescheduling. The unified communication bus (114) allows continuous feedback and data consistency among all components, thereby achieving a self-correcting, policy-compliant workforce scheduling system.

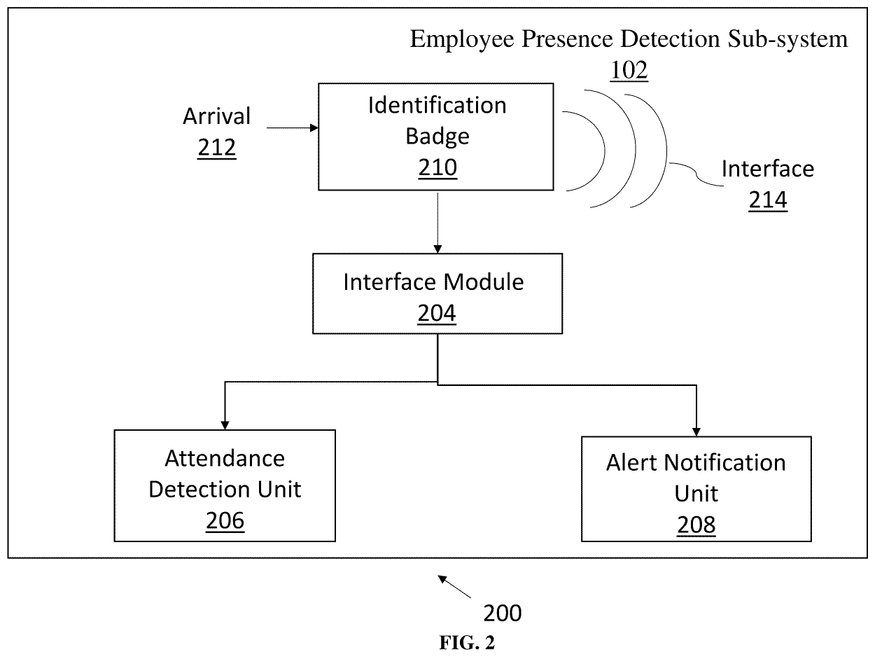

FIG. 2 illustrates an internal functional architecture of an employee presence detection subsystem (102), in accordance with an embodiment of the present invention. The subsystem (102) forms a core component of the employee shift scheduling and attendance management system and is configured to detect, verify, and record the arrival of employees at a designated worksite while simultaneously supporting alert and notification functionalities.

The subsystem (102) comprises an identification badge or token (210), an interface module (204), an attendance detection unit (206), and an alert notification unit (208). The identification badge (210) serves as an employee authentication device and may include one or more communication technologies such as RFID, NFC, Bluetooth Low Energy (BLE), or biometric sensors. The identification badge (210) is uniquely associated with each employee and securely stores an employee identification code or encrypted credentials.

When an employee carrying the identification badge (210) arrives at the worksite, as shown by the arrival event (212), the badge (210) establishes communication with the subsystem via a short-range interface channel (214). The communication may occur through wireless signal exchange or proximity-based detection, depending on the configuration of the system. Upon successful detection, the subsystem (102) registers the employee's presence and transmits an authentication request to the interface module (204).

The interface module (204) acts as the central control point within the employee presence detection subsystem (102). It receives credential data from the identification badge (210), performs data integrity verification, and cross-references the credentials with stored records within the main scheduling database of the system (100). Once validated, the interface module (204) triggers the attendance detection unit (206) to record the arrival time, update the shift attendance log, and synchronize the information with the real-time monitoring module (106) through the communication bus (114).

In parallel, the alert notification unit (208) is activated to monitor for exceptional events such as late arrivals, unregistered badge usage, or missed check-ins. When such an event is detected, the alert notification unit (208) automatically generates a real-time alert that is transmitted to the communication module (108). The alert can be configured to notify the employee via push message or the management user through SMS, email, or dashboard notification. The alert notification unit (208) thereby ensures proactive workforce supervision and minimizes unreported attendance deviations.

In some embodiments, the employee presence detection subsystem (102) further integrates multi-factor authentication, requiring biometric verification or geolocation confirmation in addition to badge scanning. Such implementations enhance security and prevent impersonation or proxy attendance. In other embodiments, the interface module (204) may cache attendance data locally in offline mode and automatically synchronize with the central system once network connectivity is restored.

Collectively, the identification badge (210), interface module (204), attendance detection unit (206), and alert notification unit (208) operate as a unified subsystem to automate the detection and validation of employee presence, while ensuring secure communication, auditability, and compliance with organizational attendance policies.

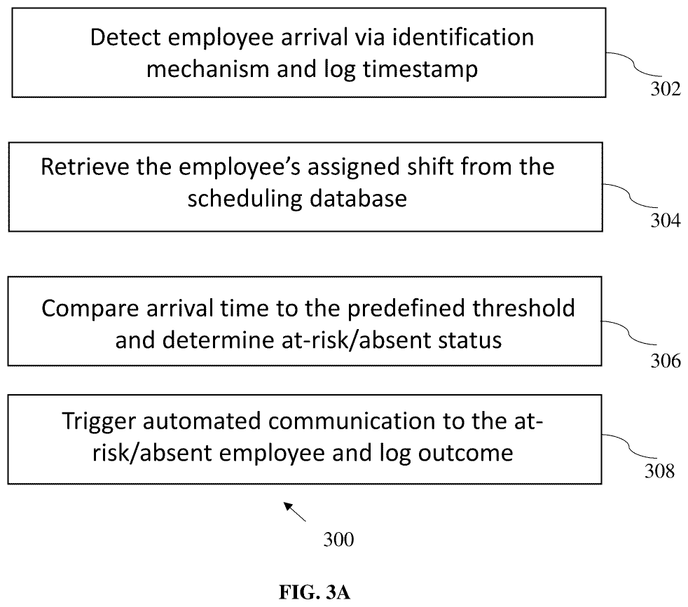

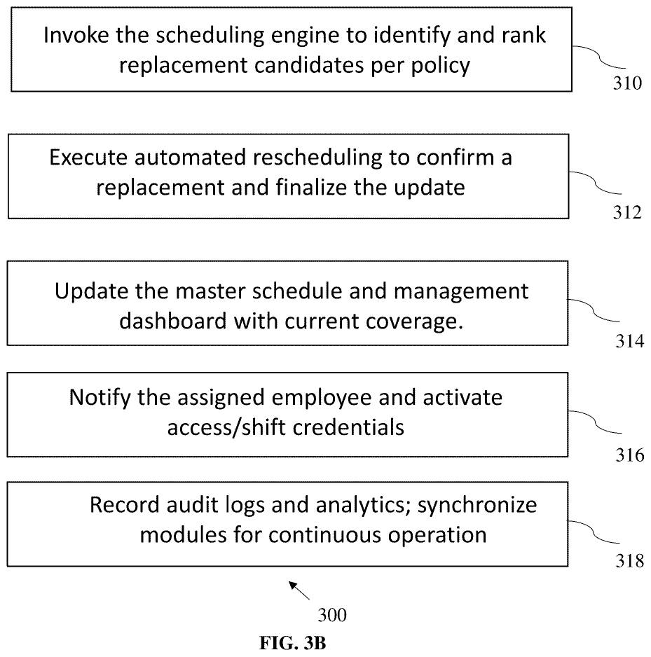

FIGS. 3A-3B collectively depict a method (300) executed by the employee shift scheduling and attendance management system (100) for automated attendance handling and shift rescheduling; data and control messages among modules are conveyed over the communication bus (114), and while illustrated sequentially, certain operations may execute in parallel without departing from the invention.

At 302, the employee presence detection subsystem (102) detects the arrival of an employee via an identification mechanism (e.g., RFID/NFC badge, BLE/mobile credential, or biometric input), validates the credential locally, timestamps the arrival event with reader and geofence metadata, and commits the authenticated presence record to the attendance store through the bus (114).

At 304, the shift scheduling subsystem (104) retrieves the employee's assigned shift by querying the master schedule using the authenticated employee identifier, returns role, location, start/end, and any skill/certification constraints, and provides this dataset to the real-time monitoring module (106) and the scheduling engine (110) for downstream evaluation.

At 306, the real-time monitoring module (106) compares the recorded arrival time against the scheduled start and a configurable pre-shift threshold, determines an on-time, at-risk, or absent state accordingly, and posts the resulting status to the system message bus; when the threshold is breached without a valid arrival event, the employee is flagged at-risk, and upon start-time lapse the state transitions to absent.

At 308, upon an at-risk or absent classification, the communication module (108) automatically initiates outreach to the affected employee via one or more configured channels (SMS, push, email, or automated voice), transmits a payload identifying the shift and offering response options (e.g., “running late,” “cannot attend,” ETA), parses and logs any return communication, updates the management dashboard with the interpreted status, and—if a compliant confirmation is received within a grace window—closes the event as a late-arrival resolution; otherwise, upon expiry of the grace window or receipt of an unavailability response, signals over the bus (114) to invoke the scheduling engine (110) for replacement identification.

At 310, the scheduling engine (110) evaluates a candidate pool for replacement by applying weighted policy criteria—including overtime exposure, skill/certification fit, training currency, performance history, seniority, availability, and staffing-ratio constraints—generates a ranked list of eligible employees with compliance annotations, and publishes the ordered slate to the automated rescheduling module (112).

At 312, the automated rescheduling module (112) orchestrates the vacancy-fill pipeline wherein its detection submodule confirms the open slot, the policy submodule enforces applicable labour and budget rules (e.g., maximum hours, mandatory rest, cost caps), the ranking submodule selects the next best eligible candidate(s) from the ordered slate, and the outreach submodule dispatches offers and records acceptances; upon acceptance, the scheduling submodule writes the confirmed assignment to the master schedule and closes the vacancy, propagating updates system-wide.

At 314, the system updates the master schedule within the shift scheduling subsystem (104), refreshes the management dashboard with current coverage, highlights any policy deviations or residual risk, and issues automated alerts where staffing-ratio or skills-mix thresholds require attention.

At 316, the newly assigned employee is notified via the mobile/web application of the confirmed shift, and, where applicable, access permissions linked to the identification badge/credential are activated for the specified site and time window, together with any role-specific task or training prerequisites.

At 318, the system records immutable audit logs of decisions, overrides, latencies, and communications; updates analytics for KPIs including fill time, overtime avoidance, attendance reliability, policy deviations, and cost adherence; synchronizes state across modules via the communication bus (114); and, in certain embodiments, retrains or tunes the scheduling engine (110) models using accumulated historical data to improve future ranking accuracy and response time.

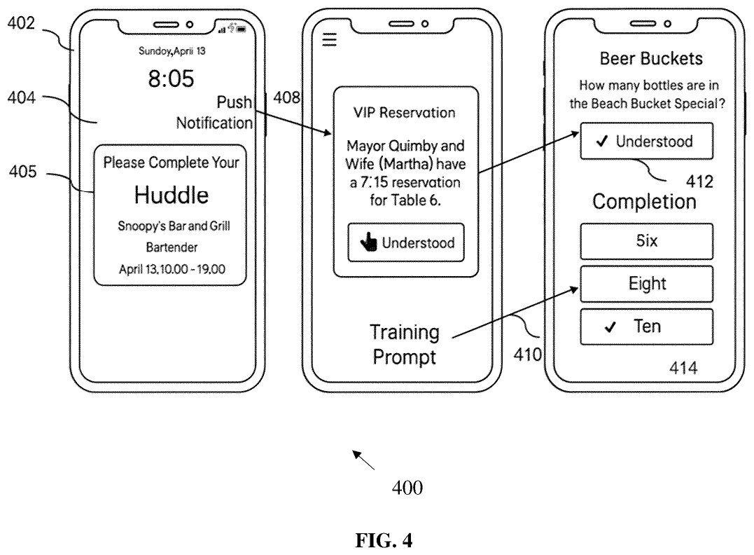

FIG. 4 illustrates a mobile-application workflow of the training and compliance content delivery platform integrated with the timecard sign-in process. The sequence begins at the mobile device (402), which executes an employer-provided application (or standards-compliant web view) that monitors for an employee sign-in event and initiates the session for delivering pre-shift information and interactive prompts. As described in the disclosure, the platform is a complementary extension to the electronic timecard system and presents a session (“huddle”) when a sign-in is detected, delivered either in-app or via MMS link if the app is not configured or not acknowledged.

Upon launch, the user-interface screen (404) renders a session landing card that anchors the prompt sequence and records time stamps for audit. The platform then issues an input prompt (406) requesting that the user complete the required pre-shift session (e.g., profile confirmations and acknowledgements). In accordance with the design set forth in the disclosure, each session consists of a series of prompts—some informational (acknowledge-to-advance) and some interactive (multiple choice)—and all incorrect answers must be corrected before the next prompt is presented, thereby enforcing comprehension.

After the initial acknowledgement is captured, the application generates a push notification (408) that surfaces time-sensitive operational information—illustratively, a “VIP reservation for a customer” in line with the use cases of conveying VIP notices, daily updates, and compliance reminders prior to the shift. The notification is displayed within the same session so that acknowledgement is logged with the session identifier and the employee identifier.

When the user actuates the acknowledgement control—shown as “Understood” (412)—the system advances to a role-specific training interaction implemented as a training prompt (410). In one embodiment, the prompt requests an operational input such as product-knowledge confirmation; for example, the interface displays a multiple-choice query (“How many bottles are in the Bucket Special?”), and the user selects a value—illustratively “10” (414)—with immediate validation feedback. Consistent with the disclosure, an incorrect selection triggers corrective messaging and requires the user to choose the correct option before the session can proceed, ensuring that all wrong answers are corrected prior to advancement.

The prompts shown in FIG. 4 are representative, and the actual set may be assembled dynamically by management using predefined templates with text, optional imagery, and configurable buttons, assignable to all employees, to role-based cohorts, to KPI-filtered groups, or to personnel linked to flagged safety/recheck events—thus enabling targeted pre-shift instruction and assessments.

Completion events, corrections, and acknowledgement timestamps generated by the sequence of (406)→(408)→(412)→(410/414) are logged for analytics as KPIs (e.g., delay between clock-in and completion; incorrect-answer counts), which may subsequently influence future schedules, rewards/bonus eligibility, or training requirements within the employer's management platform.

In some embodiments consistent with the disclosure, location controls verify that the session is completed on-premises, and, if needed, the same prompts can be delivered via a shared terminal where the employee authenticates with the assigned badge; incomplete sessions may appear as alerts on a manager dashboard to ensure onboarding is completed prior to or during the shift.

The present invention provides a technically implemented system that automates workforce scheduling, attendance monitoring, and shift reassignment through a modular computing framework integrated with real-time data analytics and machine-driven decision logic. The invention introduces a concrete technical architecture for the detection, validation, and management of employee presence and shift allocation using specialized hardware and software modules interconnected over a communication bus. The technical effect of this architecture lies in reducing latency between detection and rescheduling events, thereby minimizing human intervention and ensuring continuous compliance with operational and labour regulations.

The integration of the employee presence detection subsystem, shift scheduling subsystem, real-time monitoring module, communication module, scheduling engine, and automated rescheduling module within a unified data communication framework represents a distinct advancement over conventional human-resource management software. Traditional systems rely on manual input or asynchronous data uploads, whereas the present system performs autonomous data acquisition, verification, and decision-making through synchronized real-time communication between interconnected modules. This results in an objectively measurable improvement in processing efficiency, response time, and error mitigation.

From a computing perspective, the invention introduces an optimized data-handling and decision-execution workflow that minimizes system resource consumption and communication overhead. The communication bus allows concurrent data transmission across modules, thereby avoiding conventional database polling bottlenecks associated with time-based triggers. The result is a lower computational load and improved scalability of the workforce-management process across multiple locations and employee clusters.

The invention achieves a further technical effect by embedding a machine-learning-based scheduling engine that dynamically evaluates replacement employees based on weighted parameters such as overtime limits, training history, and compliance data. Unlike rule-based or static scheduling tools, the present system implements adaptive data models that learn from historical patterns, progressively refining its decision-making accuracy over time. This enhances the predictability and reliability of workforce coverage, which is a critical technical improvement in automated enterprise resource systems.

The automated rescheduling module, comprising detection, policy, ranking, and outreach submodules, introduces an intelligent process-orchestration model that operates within real-time computing constraints. The detection submodule interacts with the monitoring and communication modules to identify gaps instantly; the policy submodule enforces programmable compliance thresholds; the ranking submodule applies algorithmic evaluation logic; and the outreach submodule automates confirmation workflows using communication APIs. Collectively, this configuration demonstrates a hardware-implemented technical process rather than a purely abstract administrative method, satisfying the industrial-applicability and technical-contribution requirements of patent law.

The invention further improves data integrity, reliability, and system responsiveness by incorporating multi-channel communication and fault-tolerant synchronization techniques. Each subsystem operates semi-independently while maintaining data consistency through continuous synchronization with the central scheduling engine. This architectural configuration ensures that even during transient network outages or high-load conditions, the system maintains operational continuity—an effect that directly enhances the robustness and resilience of digital workforce-management platforms.

The system's ability to automatically detect anomalies such as missed check-ins, delayed arrivals, and unconfirmed shift assignments allows early intervention and proactive workforce stabilization. The combination of predictive analytics and rule-based communication ensures a reduction in manual rescheduling time and prevents under-or over-staffing events. These functions are implemented through executable computer instructions, forming a machine-implemented method that directly improves the functioning of the underlying computer-network system.

The invention achieves a synergistic technical advantage by converging presence detection, AI-driven decision support, and automated communication into a unified, self-correcting scheduling framework. This integration results in a demonstrable improvement in system accuracy, response time, and reliability compared to manual or semi-automated scheduling systems. It also reduces dependency on administrative staff, minimizes error propagation across interconnected databases, and improves compliance traceability through immutable audit logs generated by the system.

In certain embodiments, the system is implemented over a cloud or hybrid infrastructure, enabling distributed computation and data synchronization across multiple enterprise locations. This distributed architecture ensures fault-tolerant scalability, while secure encryption protocols preserve the integrity of employee data and compliance records. By leveraging APIs and modular microservices, the invention provides a flexible deployment model compatible with both enterprise-grade ERP systems and standalone workforce applications.

From a network-level standpoint, the communication bus enables secure asynchronous message exchange between subsystems, achieving packet-level efficiency comparable to low-overhead transport mechanisms in high-performance computing architectures. This structure supports multi-threaded synchronization, event-driven updates, and error-recovery routines, collectively improving throughput and system resilience against communication failures.

The technical advantages of the present invention, therefore, include: (i) automated synchronization of employee-presence and scheduling data across distributed nodes; (ii) adaptive load balancing for concurrent scheduling events; (iii) algorithmic compliance validation against configurable policy matrices; and (iv) predictive communication routines that minimize idle staffing intervals. Each advantage arises from a tangible technical implementation combining hardware, firmware, and computer-executable instructions, rather than mere organizational policy automation.

By integrating automated scheduling, predictive analytics, and real-time communication within a modular and data-secure computing environment, the invention constitutes a novel technical contribution to the field of digital workforce management. It not only streamlines human-resource operations but also materially enhances the performance of computer-based scheduling systems through optimized data flow, reduced latency, and adaptive self-learning algorithms.

The present invention is applicable across multiple industries where time-sensitive, compliance-driven workforce management is essential—including healthcare facilities, manufacturing units, retail outlets, logistics centers, hospitality environments, and enterprise service operations. By automating coordination between attendance tracking, rescheduling, and compliance management, the invention provides a robust, scalable, and technically advanced framework for next-generation workforce optimization.

Accordingly, the invention provides a comprehensive workforce-scheduling and attendance-management solution that achieves both operational and technical excellence. Through its real-time synchronization, predictive scheduling logic, modular microservice architecture, and secure communication framework, the system materially improves the functioning of the computing infrastructure used in employee-management applications while ensuring compliance, data security, and performance efficiency across diverse operational domains.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

What is claimed is:

1. An employee shift scheduling and attendance management system, comprising:
an employee presence detection subsystem configured to detect arrival of at least one employee at a worksite using an identification mechanism;
a shift scheduling subsystem configured to electronically create, store, assign, and manage at least one shift schedule for the at least one employee;
a real-time monitoring module configured to compare employee arrival data with the scheduled shift and determine whether the at least one employee is at risk of missing the shift based on a predefined threshold time prior to shift commencement;
a communication module configured to automatically contact one or more employees identified as likely to be absent, and to report any response received to a management user;
a scheduling engine configured to identify and assign a replacement employee based on predefined criteria, the predefined criteria comprising at least one of an overtime limit, regulatory compliance data, training data, performance data, and seniority data, while ensuring compliance with applicable labour regulations; and
an automated rescheduling module triggered by one or more of employee call-outs and no-shows, the automated rescheduling module comprising detection, policy, ranking, and outreach submodules configured to allocate and confirm a replacement employee.

2. The system of claim 1, wherein the employee presence detection subsystem comprises an employee identification badge that interfaces with the system upon arrival, the employee identification badge is further configured for task completion, monitoring of assigned activities, and transmission of alerts and assistance notifications enabling the employee to request help, and trigger an alarm in the event of a threat.

3. The system of claim 2, wherein the employee identification badge is configured to perform one or more of: an access control of the at least one employee, a task completion of the at least one employee, a task attendance detection of the at least one employee, an alarm for an active threat, assistance with a threatening customer or a stranger, and a notification of a safety hazard, wherein the employee identification badge stores at least one alert log comprising a detail of at least one of an active alert and an archived alert.

4. The system of claim 1, wherein the predefined threshold time for expected arrival prior to the shift is electronically configurable by an employer, wherein the employer defines at least one configurable staffing-ratio policy that the scheduling engine adheres to during a schedule generation, wherein the at least one staffing ratio is derived from historical scheduling and performance data, wherein deviations from the at least one staffing-ratio policy trigger automated alerts to notify the employer, and wherein the at least one staffing-ratio policy is used by an artificial intelligence (AI) when creating future schedules.

5. The system of claim 1, wherein the scheduling engine evaluates potential replacement employees based on a weighted ranking system incorporating one or more of overtime history, skill certifications, and employee availability, and wherein the scheduling engine considers peer-group consistency to support cohesive team assignment during shift scheduling.

6. The system of claim 1, wherein the automated rescheduling module maintains a dynamic on-call list that is updated in real-time based on availability data and active shift changes.

7. The system of claim 1, wherein the scheduling engine is configured to minimize overtime while maximizing compliance with staffing budget allocations.

8. The system of claim 1, wherein individual shift slots are assigned based on one or more of specific skill, training, and performance requirements, wherein the scheduling engine uses these requirements as constraints during employee assignment, wherein policy deviation alerts are generated when the scheduling engine and manual override violates one or more of the skill and training requirements.

9. The system of claim 1, wherein at least one approved staffing level is computed based on historical and recent sales data along with a configurable sales-to-staffing budget ratio, wherein a schedule is not finalized when the schedule exceeds the approved staffing budget, unless manually overridden by an authorized user, wherein the historical sales data is further utilized to optimize shift timing and changeover patterns across different job roles.

10. The system of claim 1, wherein the automated rescheduling module comprises:
a scheduling submodule to identify at least one available employee for replacement;
a policy submodule to ensure compliance with labour regulations;
a ranking submodule to select a most suitable replacement employee based on predefined criteria;
an outreach submodule to contact identified employees and record corresponding acceptance; and
a scheduling submodule to finalize shift updates based on confirmed replacements.

11. The system of claim 1, wherein the at least one employee accesses a corresponding work schedule and responds to shift change requests via a dedicated mobile application, wherein audit logs are maintained for all automated scheduling decisions, manual overrides, and employee communications, and wherein analytics dashboards are configured to provide real-time insights into schedule efficiency, staffing costs, and attendance trends.

12. An electronic delivery platform to present informational and interactive training content to hourly employees during a process of signing into a timecard system, wherein the platform comprises:
a. a content delivery module configured to deliver training content to the hourly employees, wherein the training content is generated based on one or more of:
i. a role performed by an employee that is performing;
ii. the employee's past performance according to tracked key performance indicators (KPIs), based on quantitative performance data;
iii. performance critiques and accolades based on empirical and subjective observations during previous shifts;
iv. reminders of upcoming events; and
v. reminders of enrolled training classes;
b. a content presentation module configured to present information timely to an upcoming shift, one or more business goals, and customer needs.

13. The platform of claim 12, wherein the training content is delivered to and completed by the hourly employees through one or more of a mobile device and a web-based interface, wherein a notification indicating availability of the training content is presented on a mobile device associated with an employment record of the corresponding employee, and wherein completion of the training content is enabled on one or more of the associated mobile device and the web-based interface, using an employer-provided authentication badge for authorization on devices other than the mobile device associated with their employment record.

14. The platform of claim 12, wherein completion of the training content is tracked as a quantitative KPI, the quantitative KPI including one or more of:
c. a completion time measured between presentation of the notification and completion of the training content; and
d. a percentage of completed training content relative to a number of shifts completed.

15. The platform of claim 12, wherein the timely completion of the training content is utilized as a factor in determining eligibility of the employee for additional compensation, the additional compensation including eligibility for participation in a “Tip Pool”.

16. The platform of claim 12, where the employee becomes eligible for compensation only after completion of the training content, completion of the training content being a required step prior to activation in the timecard system.

17. The platform of claim 12, wherein completion of the training content is enabled only when a location of the employee is verified to be within a predefined geofence surrounding a corresponding worksite.
